(19) United States
(12) Patent Application Publication
(10) Pub. No.: US 2024/0152179 A1
(43) Pub. Date: May 9, 2024

(54) Cell Phone Glare and Heat Shade Device

(71) Applicant: Omar Burak, Galveston, TX (US)

(72) Inventor: Omar Burak, Galveston, TX (US)

(21) Appl. No.: 18/350,846

(22) Filed: Jul. 12, 2023

Related U.S. Application Data
(60) Provisional application No. 63/422,591, filed on Nov. 4, 2022.

(51) Int. Cl. G06F 1/16; H04M 1/11; H04M 1/21

(52) U.S. Cl. CPC G06F 1/1603; H04M 1/11; H04M 1/21

(57) ABSTRACT

The present invention relates to cell phone glare and heat shade device that protects a cell phone from direct sunlight within a vehicle to prevent glare and overheating. A housing of the device receives a cell phone which is secured within the housing via at least one fastener. A mirror mount of the device attaches around a rearview minor of a vehicle, wherein the connecting member attaches the mount to the bracket attached to the housing. In this manner, the device hangs in a suspended manner from a rearview mirror.

### CROSS-REFERENCE TO RELATED APPLICATION

The present application claims priority to, and the benefit of, U.S. Provisional Application No. 63/422,591, which was filed on Nov. 4, 2022, and is incorporated herein by reference in its entirety.

### FIELD OF THE INVENTION

The present invention relates generally to the field of vehicle cell phone holders. More specifically, the present invention relates to cell phone glare and heat shade device. A housing of the device receives a cell phone which is secured within the housing via at least one fastener. A mirror mount of the device attaches around a rearview mirror of a vehicle, wherein the connecting member attaches the mount to the bracket attached to the housing. In this manner, the device hangs in a suspended manner from a rearview mirror while the housing shields the cell phone from direct sunlight. Accordingly, the present disclosure makes specific reference thereto. Nonetheless, it is to be appreciated that aspects of the present invention are also equally applicable to other like applications, devices, and methods of manufacture.

### BACKGROUND

Drivers may use their cell phones for GPS navigation while driving. However, trying to find a place within a vehicle to position a cell phone for hands-free use can be difficult. In addition, direct sunlight shining on a cell phone within a vehicle can cause glare on the phone screen and can cause the phone to overheat.

Therefore, there exists a long-felt need in the art for a vehicle cell phone holder. There also exists a long-felt need in the art for a cell phone glare and heat shade device. More specifically, there exists a long-felt need in the art for a cell phone glare and heat shade device that protects a cell phone from glare within a vehicle. In addition, there exists a long-felt need in the art for a cell phone glare and heat shade device that protects a cell phone from overheating from direct sunlight exposure. Furthermore, there exists a long-felt need in the art for a cell phone glare and heat shade device that allows a user to use and view a cell phone in a hands-free manner while driving.

The subject matter disclosed and claimed herein, in one embodiment thereof, comprises a cell phone glare and heat shade device. The device is primarily comprised of a housing, a bracket, a mirror mount, and at least one connecting member. The housing receives a cell phone which is secured within the housing via at least one fastener. The housing may have a plurality of openings to allow a user to access the controls of the cell phone while shielding the phone from sunlight. The minor mount attaches around a rearview mirror of a vehicle, wherein the connecting member attaches the mount to the bracket attached to the housing. In this manner, the device hangs in a suspended manner from a rearview minor. In different embodiments, the connecting member may be a rope, a string, or a rigid member.

In this manner, the cell phone glare and heat shade device of the present invention accomplishes all the foregoing objectives and provides a device that protects a cell phone from glare within a vehicle. In addition, the device protects a cell phone from overheating from direct sunlight exposure. Furthermore, the device allows a user to use and view a cell phone in a hands-free manner while driving.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cell phone glare and heat shade device. The device is primarily comprised of a housing, a bracket, a minor mount, and at least one connecting member. The device and all components are preferably made from a UV-resistant plastic material.

The housing is preferably rectangular in shape to accommodate a cell phone or other smart device. In a rectangular embodiment, the housing is comprised of a top wall and a parallel bottom wall, a set of parallel side walls, and a rear wall. Each side wall may be comprised of at least one opening that allows a user to access the side buttons of a cell phone within the housing. The bottom wall may also be comprised of at least one opening and/or slot that allows at least one charging cord to enter the housing to charge the cell phone. The front surface of the rear wall may also be comprised of at least one fastener that secures a cell phone within the housing.

The rear surface of the rear wall may be comprised of at least one mounting bracket that allows at least one connecting member to connect the housing to at least one mirror mount. The minor mount attaches to the rearview minor of a vehicle. In one embodiment, the connecting member is comprised of a rope or string to allow the device to hang at a custom height from the rearview mirror. In another embodiment, the connecting member is a rigid plastic member of a fixed length that is fixedly or removably connected to the mirror mount and bracket. The rigid nature of the member in this embodiment prevents the housing from moving/rotating as the vehicle is in motion.

During use, the housing shields a cell phone within the housing from glare. In addition, the housing prevents sunlight from hitting the cell phone and overheating the cell phone. However, the openings of the housing still allow the cell phone to be easily controlled and charged.

Accordingly, the cell phone glare and heat shade device of the present invention is particularly advantageous as it provides a device that protects a cell phone from glare within a vehicle. In addition, the device protects a cell phone from overheating from direct sunlight exposure. Furthermore, the device allows a user to use and view a cell phone in a hands-free manner while driving. In this manner, the cell phone glare and heat shade device overcomes the limitations of existing methods and devices used to secure a cell phone within a vehicle that are known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an enhanced perspective view of one potential embodiment of a cell phone glare and heat shade device of the present invention in accordance with the disclosed architecture;

FIG. 2 illustrates an enhanced perspective view of one potential embodiment of a cell phone glare and heat shade device of the present invention with a cell phone within the device in accordance with the disclosed architecture;

FIG. 3 illustrates a perspective view of one potential embodiment of a cell phone glare and heat shade device of the present invention while suspended from a rearview minor in accordance with the disclosed architecture; and

FIG. 4 illustrates a flowchart of a method of using one potential embodiment of a cell phone glare and heat shade device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a vehicle cell phone holder. There also exists a long-felt need in the art for a cell phone glare and heat shade device. More specifically, there exists a long-felt need in the art for a cell phone glare and heat shade device that protects a cell phone from glare within a vehicle. In addition, there exists a long-felt need in the art for a cell phone glare and heat shade device that protects a cell phone from overheating from direct sunlight exposure. Furthermore, there exists a long-felt need in the art for a cell phone glare and heat shade device that allows a user to use and view a cell phone in a hands-free manner while driving.

The present invention, in one exemplary embodiment, is comprised of a cell phone glare and heat shade device primarily comprised of a housing, a bracket, a mirror mount, and at least one connecting member. The device and all components are preferably made from a UV-resistant plastic material, and wherein the housing is preferably rectangular in shape to accommodate a cell phone or other smart device. In a rectangular embodiment, the housing is comprised of a top wall and a parallel bottom wall, a set of parallel side walls, and a rear wall. Each side wall may be comprised of at least one opening that allows a user to access the side buttons of a cell phone within the housing. The bottom wall may also be comprised of at least one opening and/or slot that allows at least one charging cord to enter the housing to charge the cell phone. The front surface of the rear wall may also be comprised of at least one fastener that secures a cell phone within the housing.

The rear surface of the rear wall may be comprised of at least one mounting bracket. The bracket allows at least one connecting member to connect the housing to at least one minor mount. The mirror mount attaches to the rearview mirror of a vehicle. In one embodiment, the connecting member is comprised of a rope or string to allow the device to hang at a custom height from the rearview mirror. In another embodiment, the connecting member is a rigid plastic member of a fixed length that is fixedly or removably connected to the minor mount and bracket. The rigid nature of the member in this embodiment prevents the housing from moving/rotating as the vehicle is in motion.

During use, the housing shields a cell phone within the housing from glare. In addition, the housing prevents sunlight from hitting the cell phone and overheating the cell phone. However, the openings of the housing still allow the cell phone to be easily controlled and charged.

Accordingly, the cell phone glare and heat shade device of the present invention is particularly advantageous as it provides a device that protects a cell phone from glare within a vehicle. In addition, the device protects a cell phone from overheating from direct sunlight exposure. Furthermore, the device allows a user to use and view a cell phone in a hands-free manner while driving. In this manner, the cell phone glare and heat shade device overcomes the limitations of existing methods and devices used to secure a cell phone within a vehicle that are known in the art.

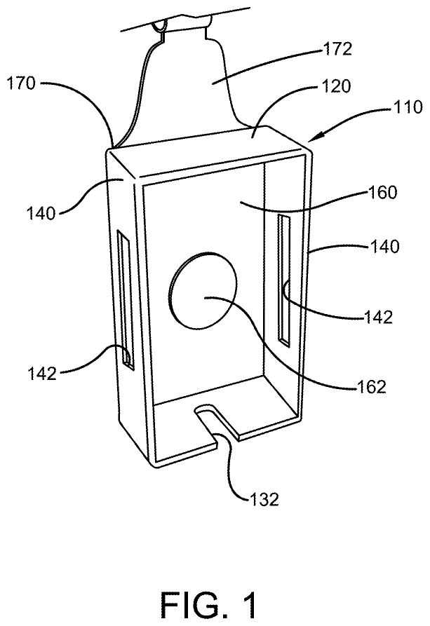

Referring initially to the drawings, FIG. 1 illustrates an enhanced perspective view of one potential embodiment of a cell phone glare and heat shade device 100 of the present invention in accordance with the disclosed architecture. The device 100 is primarily comprised of a housing 110, a bracket 172, a mirror mount 180, and at least one connecting member 190. The device 100 and all components are preferably made from a UV-resistant plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. The device 100 may be any color known in the art.

The housing 110 of the device 100 is preferably rectangular in shape to accommodate a cell phone 20 or other smart device. However, the housing 110 may be any shape so long as it can accommodate a cell phone 20 or other smart device. In a rectangular embodiment, the housing 110 is comprised of a top wall 120 and a parallel bottom wall 130, a set of parallel side walls 140, and a rear wall 150. The housing 110 may also be comprised of an insulating material.

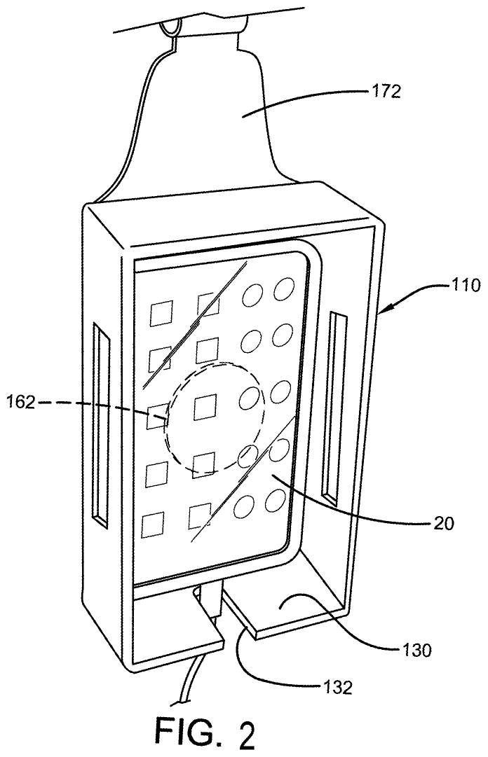

Each side wall 140 may be comprised of at least one opening 142. The opening 142 and/or slot allows a user to access the side buttons of a cell phone 20 within the housing 110. Similarly, the bottom wall 130 may be comprised of at least one opening 132 and/or slot that allows at least one charging cord to enter the housing 110 to charge the cell phone 20. The front surface 160 of the rear wall 150 may also be comprised of at least one fastener 162. The fastener 162 secures a cell phone within the housing 110, as seen in FIG. 2. The fastener 162 may be any type known in the art such as, but not limited to, a magnet, a clip, a groove, a clamp, etc. In one embodiment, the fastener 162 may be a magnetic, wireless phone charger.

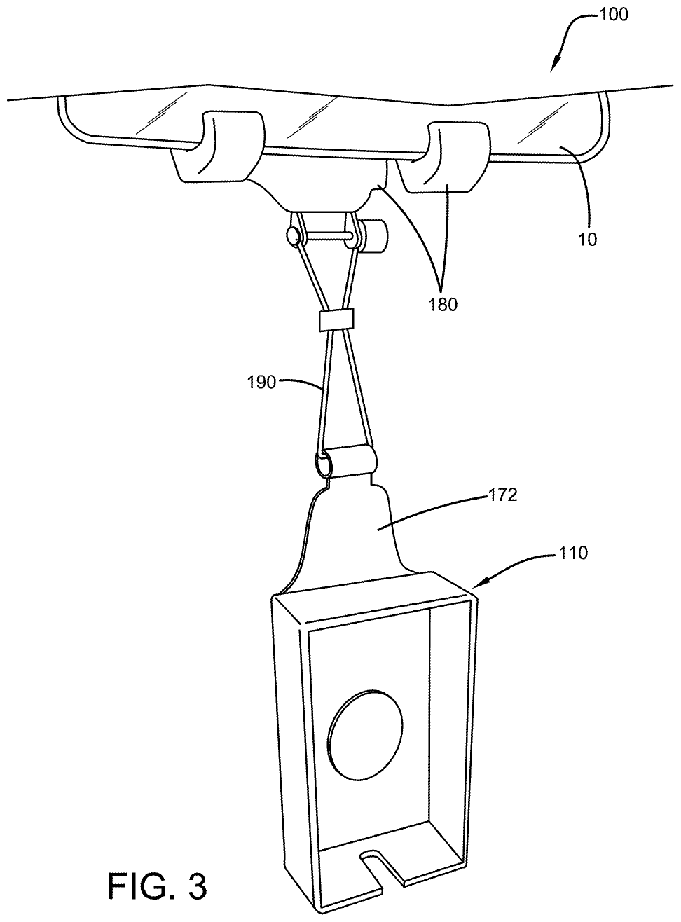

The rear surface 170 of the rear wall 150 is comprised of at least one mounting bracket 172. The mounting bracket 172 allows at least one connecting member 190 to connect the housing 110 to at least one mirror mount 180. The mirror mount 180 attaches to the rearview minor 10 of a vehicle. The mirror mount 180 may be any mounting structure that can attach to a rearview mirror 10 such as, but not limited to, a clip, a clamp, a suction cup, an adhesive fastener, a magnet, etc., as seen in FIG. 3. In one embodiment, the connecting member 190 is comprised of a rope or string to allow the device 100 to hang at a custom height from the rearview mirror 10. In another embodiment, the connecting member 190 is a rigid plastic member of a fixed length that is fixedly or removably connected to the mirror mount 180 and bracket 172. The rigid nature of the member 190 in this embodiment prevents the housing 110 from moving/rotating as the vehicle is in motion. In this embodiment, the bracket 172 may be a rotating bracket that allows the housing 110 to rotate 360 degrees. In one embodiment, the device 100 may be only comprised of a mirror mount 180 that directly attaches to the housing 110 via the connecting member 190.

During use, the housing 110 shields a cell phone 20 within the housing 110 from glare. In addition, the housing 110 prevents sunlight from hitting the cell phone 20 and overheating the cell phone 20. However, the openings 132, 142 of the housing 110 still allow the cell phone 20 to be easily controlled and charged. Further, the fastener 162 secures the cell phone 20 within the housing 110 and also allows it to be easily removed 110 as needed.

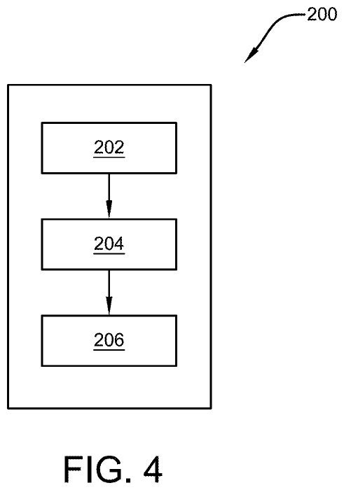

The present invention may also be comprised of a method of use 200, as seen in FIG. 4. First, a cell phone glare and heat shade device 100 is provided, the device 100 comprised of any component mentioned supra [Step 202]. Then, the mirror mount 180 of the device 100 is secured to the rearview mirror 10 of a vehicle [Step 204]. Then, a cell phone 20 (or other smart device) can be placed and secured within the housing 110 using at least one fastener 162 of the housing 110 [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cell phone glare and heat shade device” and “device” are interchangeable and refer to the cell phone glare and heat shade device 100 of the present invention.

Notwithstanding the foregoing, the cell phone glare and heat shade device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cell phone glare and heat shade device 100 as shown in the FIGS. are for illustrative purposes only, and that many other sizes and shapes of the cell phone glare and heat shade device 100 are well within the scope of the present disclosure. Although the dimensions of the cell phone glare and heat shade device 100 are important design parameters for user convenience, the cell phone glare and heat shade device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cell phone glare and heat shade device comprising:
a housing;
a fastener positioned on the housing;
a mirror mount;
a bracket; and
a connecting member that connects the mirror mount to the bracket.

2. The cell phone glare and heat shade device of claim 1, wherein the housing is comprised of a rectangular shape.

3. The cell phone glare and heat shade device of claim 1, wherein the connecting member is comprised of a rope or a string.

4. The cell phone glare and heat shade device of claim 1, wherein the mirror mount is comprised of a clip.

5. The cell phone glare and heat shade device of claim 1, wherein the mirror mount is comprised of a clamp.

6. The cell phone glare and heat shade device of claim 1, wherein the housing is comprised of a UV-resistant plastic material.

7. The cell phone glare and heat shade device of claim 1, wherein the housing is comprised of a UV-resistant plastic material.

8. The cell phone glare and heat shade device of claim 1, wherein the fastener is comprised of a magnet, a clip, a clamp, or a groove.

9. The cell phone glare and heat shade device of claim 1, wherein the housing is comprised of a bottom wall, the bottom wall comprised of a slot.

10. The cell phone glare and heat shade device of claim 1, wherein the bracket is comprised of a rotating bracket that rotates 360 degrees.

11. A cell phone glare and heat shade device comprising:
a housing comprised of a top wall, a bottom wall, a rear wall, a first side wall and a second side wall;
a fastener positioned on a front surface of the rear wall;
a mirror mount; and
a connecting member that connects the mirror mount to the housing.

12. The cell phone glare and heat shade device of claim 11, wherein the connecting member is comprised of a rigid plastic.

13. The cell phone glare and heat shade device of claim 11, wherein the fastener is comprised of a magnetic, wireless charger.

14. The cell phone glare and heat shade device of claim 11, wherein the first side wall is comprised of a first opening.

15. The cell phone glare and heat shade device of claim 14, wherein the second side wall is comprised of a second opening.

16. The cell phone glare and heat shade device of claim 15, wherein the bottom wall is comprised of a third opening.

17. The cell phone glare and heat shade device of claim 11, wherein the housing is comprised of a UV-resistant plastic material.

18. The cell phone glare and heat shade device of claim 11, wherein the mirror mount is comprised of an adhesive fastener or a suction cup.

19. A method of using a cell phone glare and heat shade device, the method comprising the steps of:
providing a cell phone glare and heat shade device comprising a housing, a fastener, a mirror mount and a connecting member;
attaching the cell phone glare and heat shade device to a rearview mirror using the minor mount; and
securing a smart device within the housing using the fastener.

20. The method of claim 19, wherein the smart device is comprised of a cell phone.
